(19) United States
(12) Patent Application Publication
(10) Pub. No.: US 2006/0028756 A1
(43) Pub. Date: Feb. 9, 2006

(54) Magnetic recording and reproducing device

(75) Inventors: Jeong-hyeob Oh, Anyang-si (KR); Myoung-joon Kim, Suwon-si (KR); Chung-hum Baik, Suwon-si (KR); Bong-joo Kim, Suwon-si (KR); Jun-young Kim, Suwon-si (KR); Young-ho Cho, Suwon-si (KR); Jae-kab Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/158,090

(22) Filed: Jun. 22, 2005

(30) Foreign Application Priority Data
Aug. 9, 2004 (KR) 2004-62283

(51) Int. Cl. G11B 5/027

(52) U.S. Cl. 360/85

(57) ABSTRACT

A magnetic recording and reproducing device for enhancing the operation efficiency by reducing the number of parts and providing an improved structure is provided. The magnetic recording and reproducing device includes a pole base assembly for loading a magnetic tape by guiding the magnetic tape so that the magnetic tape is wound on a head drum and for unloading the magnetic tape by returning the magnetic tape from the head drum; a deck having a guide rail formed thereon, the guide rail including an insertion recess into which the pole base assembly is inserted and a slit connected to the insertion recess to guide the loading and unloading of the pole base assembly; and a deviation preventing unit for preventing the deviation of the pole base assembly inserted into the guide rail.

### CROSS-REFERENCE TO RELATED APPLICATIONS

This application claims benefit under 35 U.S.C. § 119(a) from Korean Patent Application No. 2004-62283 filed on Aug. 9, 2004 in the Korean Intellectual Property Office, the entire content of which is hereby incorporated by reference.

### BACKGROUND OF THE INVENTION

1. Field of the Invention

The present invention relates to a magnetic recording and reproducing device which records and reproduces information on and from a recording medium such as a tape.

2. Description of the Related Art

Recently, miniaturized portable image photographing devices being usable in outdoor events, hobby activities, and leisure activities are greatly in demand. According to the recent trend, conventional analog type image photographing products are being replaced by digital cameras, digital camcorders, and the like, as the use of digital images becomes more mainstream.

As is generally known, a camcorder is an image-photographing device that provides functions for recording, reproducing, and editing image information as the functions of a tape recorder and a camera are combined together in one body. Such an image photographing device typically uses a magnetic tape of, for example, 8 mm, 6 mm, and 4 mm as a recording medium. Therefore, a magnetic recording and reproducing device for scanning a magnetic tape by means of a magnetic head and recording and reproducing information to and from the tape is mounted to a typical camcorder.

Generally, the magnetic recording and reproducing device includes a main deck to which a head drum for scanning a magnetic tape and recording and reproducing information is rotatably installed, and a sub-deck which is reciprocally and slidably installed to the main deck. If a tape cassette is mounted to the sub-deck, the sub-deck is moved towards the head drum to be loaded. A pair of pole base assemblies slidably installed to the main deck withdraw the magnetic tape so as to be wound on the head drum.

Therefore, a separate rail plate which has a guide rail for guiding the movement of the pole base assemblies, is installed in the main deck.

A tension pole for guiding the traveling of the magnetic tape, a capstan shaft, pinch roller, and a review pole are installed on the main deck.

The above-mentioned magnetic recording and reproducing device includes many component elements including the sub-deck installed on the main deck, and the rail plate. For this reason, the structure of the magnetic recording and reproducing device is complicated to manufacture, decreasing productivity and increasing production costs.

Therefore, there are continuous efforts to develope a magnetic recording and reproducing device capable of loading and unloading a magnetic tape just using only one deck after the sub-deck is removed. Furthermore, a structure is being developed in which a guide rail for guiding the movement of the pole base assembly is directly installed to the deck, instead of using the rail plate in addition to the sub-deck.

Accordingly, there is a need for a recording and reproducing apparatus having a simplified structure for loading and unloading a tape.

### SUMMARY OF THE INVENTION

Embodiments of the present invention solve at least the problems of the prior art discussed above and provide other advantages as will be apparent from the following description. Accordingly, it is an aspect of the present invention to provide a magnetic recording and reproducing device which has an improved structure in which the number of parts are reduced and pole base assemblies are engaged with guide rails formed in a deck to be stably operated.

In order to accomplish the above-mentioned aspects, the magnetic recording and reproducing device includes a pole base assembly for loading a magnetic tape by guiding the magnetic tape so that the magnetic tape is wound on a head drum, and for unloading the magnetic tape by returning the magnetic tape from the head drum; a deck having a guide rail formed thereon, the guide rail including an insertion recess into which the pole base assembly is inserted and a slit connected to the insertion recess to guide the loading and unloading of the pole base assembly; and a deviation preventing unit for preventing the deviation of the pole base assembly inserted into the guide rail.

Preferably, the deviation preventing unit includes a pivoting unit pivotally installed in the deck for restricting movement of the pole base assembly into an insertion recess when the pole base assembly is unloaded; and a restriction boss fixed to the deck for restricting the pivoting unit from being moved by being pushed by the pole base assembly moving in the unloading direction.

Preferably, the pivoting unit includes a pinch arm installed in the deck to be moved between a first position in which the traveling of the magnetic tape is guided when loading the pole base assembly and a second position in which the movement of the pole base assembly is restricted when unloading the pole base assembly, a pinch roller installed at one end of the pinch arm, and an interfering boss which is extended by a predetermined distance from the pinch arm to make contact with the pole base assembly at the second position.

Preferably, the pivoting unit further includes a review arm installed coaxially with the pinch arm to be pivoted for guiding the magnetic tape, and a spring which connects the review arm to the pinch arm.

Preferably, the interfering boss is integrally formed in the pinch arm.

Preferably, the restriction boss is integrally formed in the deck such that the restriction boss is protruded at a predetermined height.

Preferably, the deviation-preventing unit includes a pivoting unit pivotally installed in the deck for restricting movement of the pole base assembly into the insertion recess when unloading the pole base assembly, and a connection movement unit movably installed in the deck for restricting the pivoting range of the pivoting unit.

Preferably, the connection movement unit includes a sliding member slidably installed in the deck, and a connection movement member rotatably installed in the deck, which is moved in connection with the sliding member and the pivoting member respectively.

Preferably, the deviation preventing unit further includes a restriction boss which is fixed to the deck and restricts the pivoting unit from being pushed by the pole base assembly moving in an unloading direction.

### BRIEF DESCRIPTION OF THE DRAWINGS

The above aspects and features of the present invention will be more apparent by describing certain embodiments of the present invention with reference to the accompanying drawings, in which:

FIG. 1 is an exploded perspective view illustrating a magnetic recording and reproducing device according to an embodiment of the present invention;

FIG. 2 is a plan view illustrating the magnetic recording and reproducing device of FIG. 1;

FIG. 3 is an exploded perspective view illustrating essential parts of the magnetic recording and reproducing device of FIG. 1;

FIG. 4 is a plan view illustrating a loading state in FIG. 2; and

FIGS. 5A through 5C are schematic perspective views which are drawn to explain the assembling processes of pole base assemblies in FIG. 1.

Throughout the drawings, like reference numbers should be understood to refer to like features, elements, and structures.

### DETAILED DESCRIPTION OF EXEMPLARY EMBODIMENTS

Hereinafter, a magnetic recording and reproducing device according to an exemplary embodiment of the present invention will be described with reference to the attached drawings.

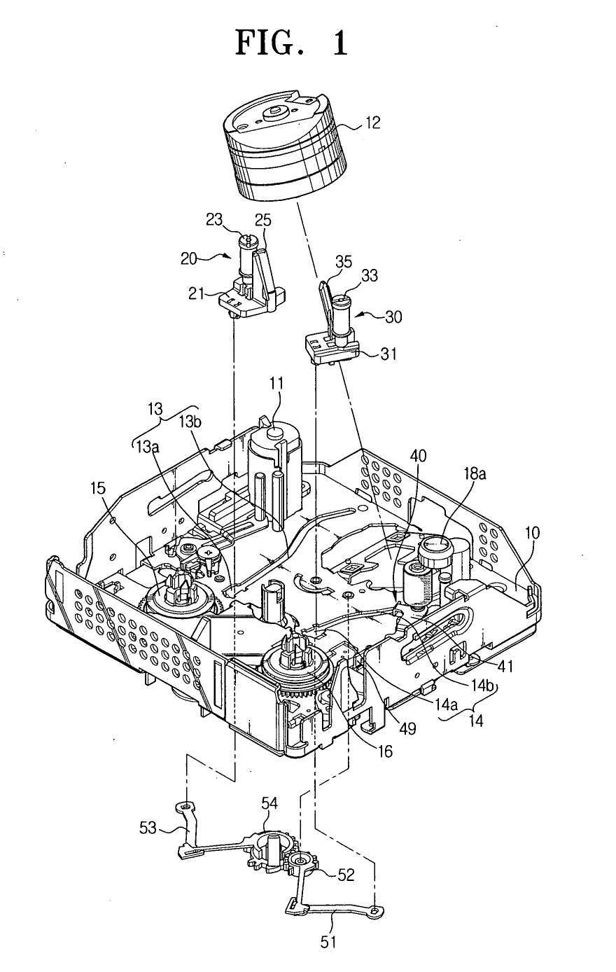

FIG. 1 shows a magnetic recording and reproducing device according to an embodiment of the present invention. The device includes a deck 10 in which a series of driving units such as a loading motor 11 and a head drum 12 are installed. A pair of pole base assemblies 20 and 30 are slidably installed in the deck 10. A deviation preventing unit 40 prevents the pole base assemblies 20 and 30 from being deviated from the deck 10.

The deck 10 is a one-chassis type deck as its four sidewalls are preferably integrally formed, and does not require a conventional sub-deck. The deck 10 has a pair of guide rails 13, 14 in which the pole base assemblies 20, 30 are respectively connected to be reciprocally moved. The guide rails 13, 14 respectively have insertion recesses 13a, 14a into which the pole base assemblies 20, 30 are inserted for assembling, and slits 13b, 14b which are connected to the insertion recesses 13a, 14a. The pole base assemblies 20, 30, which are inserted into and engaged with the insertion recesses 13a, 14a, are loaded so that a magnetic tape is wound on a head drum 12, or unloaded to return the magnetic tape, while they are reciprocally moved along the slits 13b and 14b.

The pair of pole base assemblies 20, 30 may respectively include pole bases 21, 31 moving along the guide rails 13, 14, and a plurality of guide members 23, 25 and 33, 35 which are supported by the pole bases 21, 31 to guide the traveling of a magnetic tape. The shape and the number of the guide members 23, 25 and 33, 35 may be varied in the embodiments.

The pair of pole base assemblies 20, 30 are connected to end portions of links 51, 53 in the state that the pole base assemblies 20, 30 are respectively inserted into the insertion recesses 13a, 14a. The links 51, 53 are link-connected to loading gears 52, 54 which are rotatably installed on the lower side of the deck 10. The loading gears 52, 54 are rotated in association with each other to load or unload the pole base assemblies 20, 30.

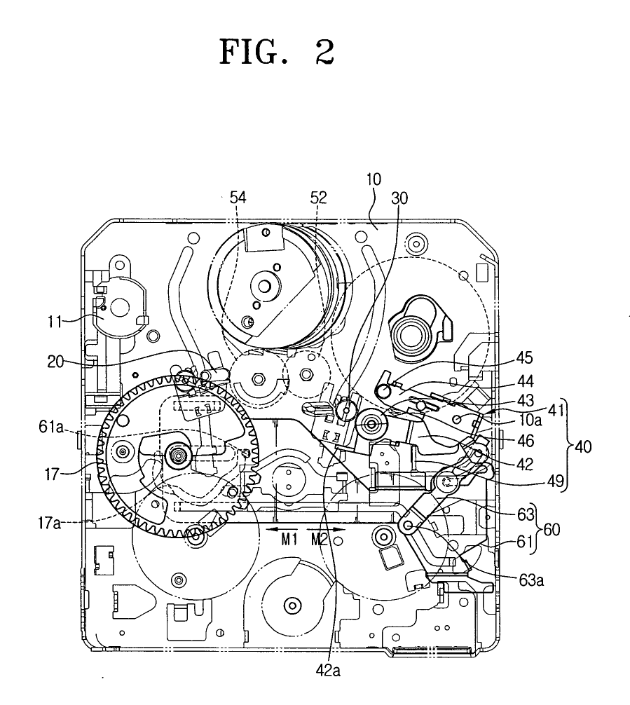

One of the loading gears 52, 54, as shown in FIG. 2, is connected to and moved in association with a main cam gear 17 installed in the deck 10. The main cam gear 17 is rotated by the power transferred from the loading motor 11 through a power transmission unit (not shown).

A pair of reel tables 15, 16 with which a tape reel of a tape cassette is engaged is installed in the deck 10.

Even though the pole base assemblies 20, 30 are connected to the links 51, 53 in the state that they are inserted into the insertion recesses 13a, 14a, they can be withdrawn through the insertion recesses 13a, 14a. Therefore, the deviation preventing unit 40 is provided to prevent the pole base assemblies 20, 30 from being separated from the guide rails 13, 14. The deviation preventing unit 40 includes a pivoting unit 41 which is pivotably installed in the deck 10, and a connection movement unit 60 and a restriction boss 49 which are installed in the deck 10 and restrict the pivoting range of the pivoting unit 41.

The pivoting unit 41 includes a pinch arm 42 which is pivotably installed in the deck 10, a review arm 44 which is installed coaxially with and pivoted together with the pinch arm 42, and a spring 46 which connects the pinch arm 42 with the review arm 44. A pinch roller 43 is rotatably installed to a free end of the pinch arm 42.

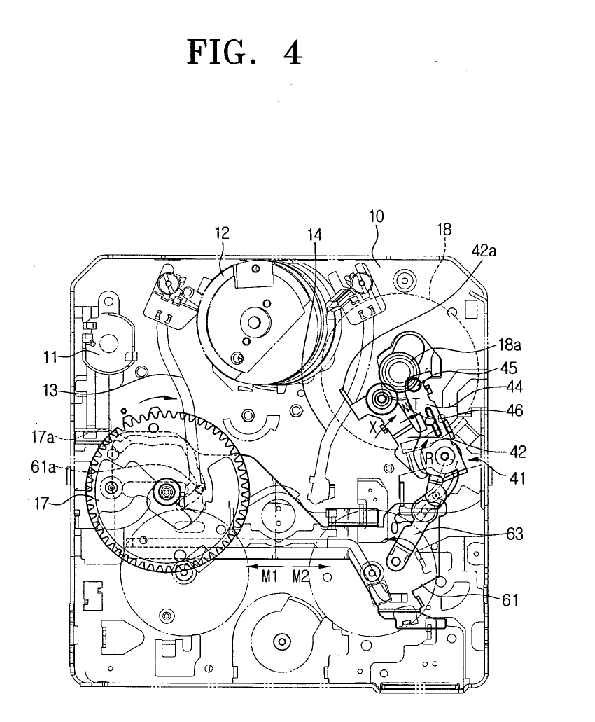

The pinch arm 42 is pivoted to a first position as shown in FIG. 4 to guide the traveling of a magnetic tape when the pole base assemblies 20, 30 are loaded. In the first position, the pinch roller 43 is pressed to a capstan shaft 18a to guide the traveling of the magnetic tape. The capstan shaft 18a is rotated by a capstan motor 18 which is installed on the lower side of the deck 10. The power of the capstan motor 18 is used to drive the reel tables 15, 16.

A review pole 45 is installed at an end portion of the review arm 44. When the review arm 44 is moved to the first position together with the pinch arm 42, the review pole 45 guides the traveling of the magnetic tape.

The pivoting range of the pivoting unit 41 is restricted since it is moved in connection with the connection movement unit 60 which is movably installed in the deck 10. The connection movement unit 60 includes a sliding member 61 which is reciprocally and slidably installed in the deck 10 by a main cam gear 17, and a connection movement member 63 which connects the sliding member 61 to the pivoting unit 41. The details of the connection mechanism of the connection movement unit 60 and the pivoting unit 41 will be described as follows.

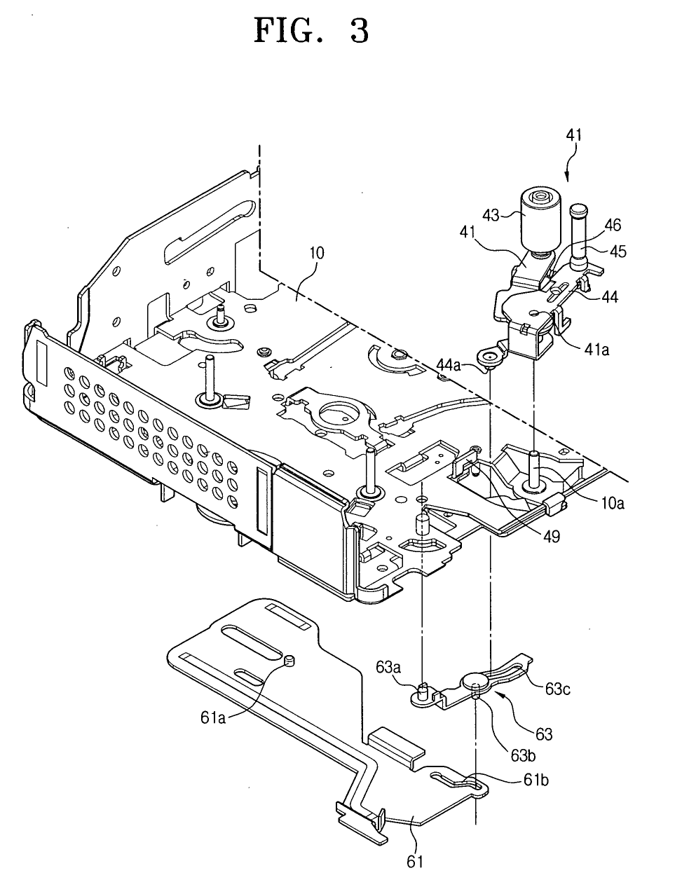

As shown in FIGS. 2 and 3, the sliding member 61 has a cam boss 61a which is inserted into a cam recess 17a of the main cam gear 17. Therefore, the sliding member 61 is moved in the M1 direction or in the M2 direction according to the rotating direction of the main cam gear 17. The sliding member 61 is connected to the pivoting unit 41 through the connection movement member 63. A pivoting pin 63a which is provided at one end of the connection movement member 63 is rotatably engaged with the deck 10. A connection movement pin 63b which is provided substantially at the center of the connection movement member 63 is connected to a cam recess 61b formed in the sliding member 61. A connection movement pin 44a provided in the pivoting unit 41 is engaged with the cam recess 63c provided at the other end portion of the connection movement member 63, and is moved in connection. The connection movement pin 44a is integrally formed in the review arm 44. By means of the above-described structure, when the sliding member 61 is moved in the M1 direction, as shown in FIG. 4, the pivoting unit 41 is moved in connection with the connection movement member 63, and is pivoted in the R direction and thus moved to the first position. If the sliding member 61 is moved in the M2 direction in the first position of FIG. 4, the pivoting unit 41 is moved to the second position as shown in FIG. 2. As described above, the pivoting range of the pivoting unit 41 is limited by the mechanism in which the sliding member 61 is mutually moved in connection with the connection movement member 63.

An interfering boss 42a is provided in the pinch arm 42. Preferably, the interfering boss 42a is integrally extended from the pinch arm 42 by a predetermined distance in which it is crossed with the moving path of the pole base assembly 30. When the pinch arm 42 is moved to the second position as shown in FIG. 2, the interfering boss 42a makes contact with the pole base assembly 30. Thus, the pole base assembly 30 is prevented from being moved to the insertion recess 14a when it is unloaded.

The restricting boss 49 is integrally formed in the deck 10 such that it is protruded at a predetermined height. The restricting boss 49 restricts the pinch arm 42 so that the pinch arm 42 is stopped at the second position to prevent the pinch arm 42 from being pushed by the pole base assembly 30 and thus being forcibly moved further.

Since the loading gears 52, 54 are connected so that they are moved in connection with each other, if the movement of one pole base assembly 30 of the pair of pole base assemblies 20, 30 is restricted, the other pole base assembly 20 is restricted from being moved into the insertion recess 13a.

By the structure of the present invention described as above, the pole base assemblies 20, 30 engaged with the guide rails 13, 14 are prevented from being moved into the insertion recess 13a, 14a by the deviation preventing unit 40.

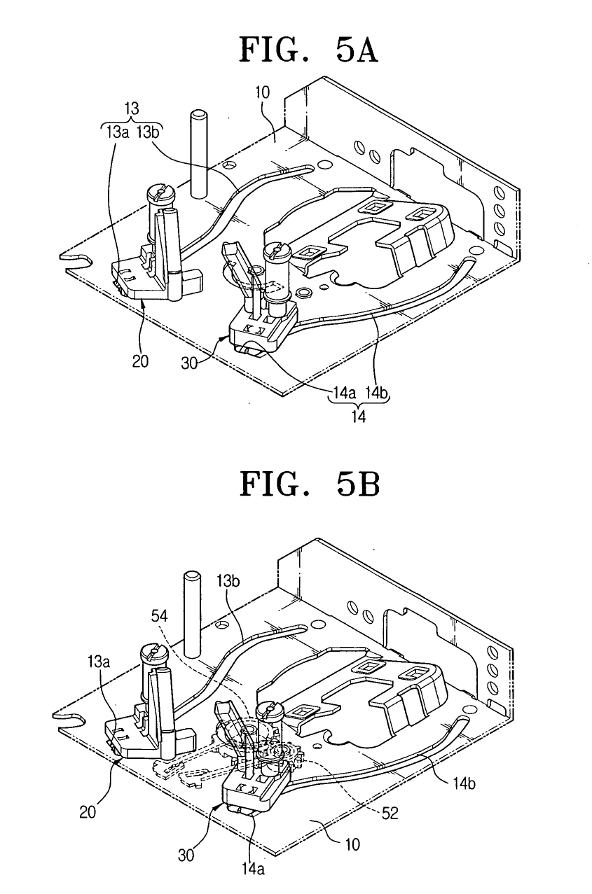

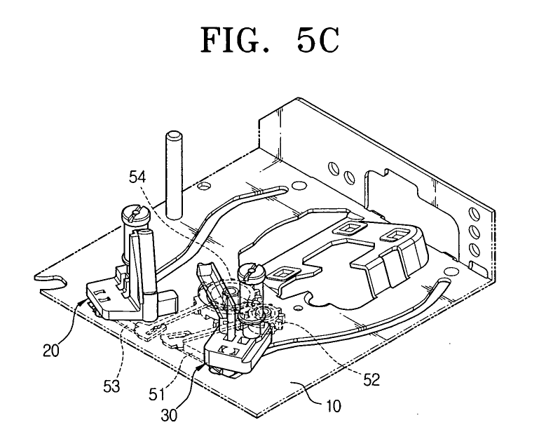

First, as shown in FIG. 5A in the case of the above-mentioned magnetic recording and reproducing device, the pair of pole base assemblies 20, 30 are inserted into the insertion recesses 13a, 14a of the deck 19 and are assembled to be slidably moved on the slits 13b, 14b.

Thereafter, as shown in FIG. 5B, the loading gears 52, 54 are slidably engaged with the bottom surface of the deck 10. One loading gear 54 is assembled in a rotatably driven state as connected to the main cam gear 17 such that the loading gear 54 is in connection with the loading motor 11 in power.

As shown in FIG. 5C, the pair of pole base assemblies 20, 30 are assembled to be connected with the loading gears 52, 54 by the links 51, 53 respectively in a state in which they are moved in connection with each other.

As described above, after the pole base assemblies 20, 30 are slidably engaged with the guide rails 13, 14 of the deck 10, the pivoting unit 41 is assembled to the deck 10. More specifically, as shown in FIG. 3, the pivoting unit 41 is engaged with the deck 10 as the fixing shaft 10a protruded from the deck 10 is inserted into the pivoting shaft hole 41a of the pivoting unit 41. Next, the connection movement member 63 and the sliding member 61 are assembled on the bottom surface of the deck 10.

As shown in FIG. 2, the interfering boss 42a of the pinch arm 42 is assembled to be located forward relative to the unloading direction of the pole base assembly 30.

In the magnetic recording and reproducing device structured as above according to an embodiment of the present invention, the main cam gear 17 is rotatably driven in the arrow direction (counterclockwise direction), the pair of pole base assemblies 20, 30 are moved towards the head drum 11 along the guide rails 13, 14 such that a magnetic tape is wound on the head drum 11. Concurrently, the sliding member 61 is moved in the M1 direction so that the connection movement member 63 is pivoted in the counterclockwise direction about the pivoting pin 63a. Thus, the pivoting unit 41 is pivoted in the clockwise direction in connection with the connection movement member 63. As shown in FIG. 4, each of the pole base assemblies 20, 30 is moved to an end portion of each of the guide rails 13, 14, and the pinch roller 43 is moved in the arrow X-direction to be pressed on the capstan shaft 18a. The review arm 44 is pressed in the arrow T-direction through the connection movement member 63. That is, the pinch arm 42 and the review arm 44 are pivoted at the same time until the pinch roller 43 makes contact with the capstan shaft 18a. After the pinch roller 43 makes contact with the capstan shaft 18a, only the review arm 44 is pressed further to be moved. Therefore, the pinch arm 42 is pressed on the capstan shaft 18a by the resilient force of the spring 46 connected to the review arm 44 to guide the magnetic tape that travels between the capstan shaft 18a and the pinch roller 43.

In FIG. 4, the main cam gear 17 is rotated in the clockwise direction to unload a magnetic tape. The pole base assemblies 20, 30 and the pivoting unit 41 are returned at the same time to an initial position as shown in FIG. 2. Since the moving ranges of the sliding member 61 and the connection movement member 63 which are moved in connection with each other are restricted, the pinch arm 42 is restricted from being pivoted in the counterclockwise direction at a predetermined position. The interfering boss 42a is located at the position adjacent to the insertion recess 14a. In this state, when the pole base assembly 30 is returned towards the insertion recess 14a along the slit 14b, it is restricted from being moved further as it makes contact with the interfering boss 42a. The pole base assembly 20, which is moved in connection with the pole base assembly 30 by driving gears 52, 54, cannot be moved toward the insertion recess 13a and is stopped. Thus, the pole base assemblies 20, 30 are prevented from being deviated through the insertion recesses 13a, 14a.

More preferably, the counterclockwise pivoting range of the pinch arm 42 can be more securely restricted by the restriction boss 49 formed in the deck 10. Even though the force by which the pole base assembly 30 is returned towards the insertion recess 14a is further applied, the pinch arm 42 is caught by the restriction boss 49 so that it is prevented from being moved further.

As described above, according to an embodiment of the present invention, the pole base assemblies can be prevented from being deviated from the guide rails formed in the deck. Therefore, the reliability of the product can be increased by preventing the disorder and the malfunctioning of the device caused by deviations of the pole base assemblies.

What is claimed is:

1. A magnetic recording and reproducing device comprising:
a pole base assembly for loading a magnetic tape by guiding the magnetic tape so that the magnetic tape is wound on a head drum and for unloading the magnetic tape by returning the magnetic tape from the head drum;
a deck having a guide rail formed thereon, the guide rail including an insertion recess into which the pole base assembly is inserted and a slit connected to the insertion recess to guide the loading and unloading of the pole base assembly; and
a deviation preventing unit for preventing the deviation of the pole base assembly inserted into the guide rail.

2. The magnetic recording and reproducing device of claim 1, wherein the deviation preventing unit comprises:
a pivoting unit pivotally installed in the deck for restricting movement of the pole base assembly into an insertion recess when the pole base assembly is unloaded; and
a restriction boss fixed to the deck for restricting the pivoting unit from being moved by being pushed by the pole base assembly moving in the unloading direction.

3. The magnetic recording and reproducing device of claim 2, wherein the pivoting unit comprises:
a pinch arm installed in the deck to be moved between a first position for guiding the traveling of the magnetic tape during the loading and a second position for restricting the movement of the pole base assembly during the unloading;
a pinch roller installed at one end of the pinch arm; and
an interfering boss which is extended by a predetermined distance from the pinch arm to make contact with the pole base assembly at the second position.

4. The magnetic recording and reproducing device of claim 3, wherein the pivoting unit further comprises a review arm installed coaxially with the pinch arm to be pivoted, for guiding the traveling the magnetic tape; and a spring for connecting the review arm and the pinch arm.

5. The magnetic recording and reproducing device of claim 3, wherein the interfering boss is integrally formed in the pinch arm.

6. The magnetic recording and reproducing device of claim 1, wherein the restriction boss is integrally formed in the deck to be protruded at a predetermined height.

7. The magnetic recording and reproducing device of claim 1, wherein the deviation preventing unit comprises:
a pivoting unit pivotally installed in the deck for restricting movement of the pole base assembly into the insertion recess during unloading of the pole base assembly; and
a connection movement unit movably installed in the deck, for restricting the pivoting range of the pivoting unit.

8. The magnetic recording and reproducing device of claim 7, wherein the connection movement unit comprises:
a sliding member slidably installed in the deck; and
a connection movement member rotatably installed in the deck, and moving in connection with the sliding member and the pivoting member respectively.

9. The magnetic recording and reproducing device of claim 8, wherein the deviation preventing unit further comprises a restriction boss which is fixed to the deck and restricts the pivoting unit from being pushed by the pole base assembly moving in an unloading direction.

10. The magnetic recording and reproducing device of claim 7, wherein the deviation preventing unit further comprises a restriction boss which is fixed to the deck and restricts the pivoting unit from being pushed by the pole base assembly moving in an unloading direction.
